(19) United States
(12) Patent Application Publication
(10) Pub. No.: US 2013/0076872 A1
(43) Pub. Date: Mar. 28, 2013

(54) System and Method of Detecting and Correcting an Improper Rendering Condition in Stereoscopic Images

(71) Applicant: Tzung-Ren WANG, Tainan City (TW)

(72) Inventor: Tzung-Ren WANG, Tainan City (TW)

(73) Assignee: HIMAX TECHNOLOGIES LIMITED, Tainan City (TW)

(21) Appl. No.: 13/241,670

(22) Filed: Sep. 23, 2011

(51) Int. Cl. H04N 13/04

(52) U.S. Cl. 348/51; 348/E13.075

(57) ABSTRACT

In some embodiments, a method of rendering stereoscopic images includes receiving a plurality of stereoscopic image frames to be rendered on a display screen, detecting the occurrence of an improper rendering condition in the stereoscopic image frames, and performing an action for protecting a viewer's vision when the improper rendering condition is detected. In other embodiments, systems of rendering stereoscopic images are also described.

### BACKGROUND

1. Field of the Invention

The present invention relates to systems and methods of rendering stereoscopic images, and more particularly to systems and methods that can detect and correct an improper rendering condition in stereoscopic images.

2. Description of the Related Art

For increased realism, three-dimensional (3D) stereoscopic image technology is increasingly applied in various fields such as broadcasting, gaming, animation, virtual reality, etc. To create depth perception, two sets of stereoscopic image frames are typically captured or generated to simulate the left eye view and right eye view. These two image frames can be respectively provided to the left and right eyes on a two-dimensional screen so that each of the left and right eyes can only see the image associated therewith. The brain can then recombine these two different images to produce the depth perception.

The increasing application of 3D stereoscopic rendering in the entertainment industry may raise health concerns. Indeed, it may happen that the stereoscopic content is rendered outside the safety range of binocular vision, causing viewing discomfort or even nausea in extreme cases.

Therefore, there is a need for an improved system that can detect improper rendering content and protect the viewer's vision in stereoscopic image rendering.

### SUMMARY

The present application describes systems and methods that can detect and correct an improper rendering condition in stereoscopic images. In some embodiments, the present application provides a method of rendering stereoscopic images that includes receiving a plurality of stereoscopic image frames to be rendered on a display screen, detecting the occurrence of an improper rendering condition in the stereoscopic image frames, and performing an action for protecting a viewer's vision when the improper rendering condition is detected.

In other embodiments, the present application provides a stereoscopic rendering system that comprises a display unit, and a processing unit coupled with the display unit, the processing unit being configured to receive a plurality of stereoscopic image frames, detect the occurrence of an improper rendering condition in the image frames, and perform an action for protecting a viewer's vision when the improper rendering condition is detected.

In addition, the present application also provides embodiments in which a computer readable medium comprises a sequence of program instructions which, when executed by a processing unit, causes the processing unit to detect an improper rendering condition from a plurality of stereoscopic image frames, wherein the improper rendering condition includes a pseudo stereo condition, a hyper-convergence condition, a hyper-divergence condition, and the concurrent occurrence of a scene change and a significant disparity change, and perform an action for protecting a viewer's vision when the improper rendering condition is detected.

The foregoing is a summary and shall not be construed to limit the scope of the claims. The operations and structures disclosed herein may be implemented in a number of ways, and such changes and modifications may be made without departing from this invention and its broader aspects. Other aspects, inventive features, and advantages of the invention, as defined solely by the claims, are described in the non-limiting detailed description set forth below.

### BRIEF DESCRIPTION OF THE DRAWINGS

FIG. 1 is a simplified block diagram illustrating one embodiment of a stereoscopic rendering system;

FIG. 2A is a schematic diagram illustrating one embodiment of a data analysis unit configured to detect an improper rendering condition induced by the occurrence of a pseudo stereo condition;

FIG. 2B is a schematic diagram illustrating one embodiment of detecting a pseudo stereo condition;

FIG. 3 is a flowchart of exemplary method steps to detect the occurrence of a pseudo stereo condition;

FIG. 4A is a schematic diagram illustrating one embodiment of a data analysis unit configured to detect an improper rendering condition owing to the occurrence of hyper-convergence of hyper-divergence;

FIG. 4B is a schematic diagram illustrating one embodiment for correcting a hyper-convergence or a hyper-divergence condition;

FIG. 4C is a schematic diagram illustrating another embodiment for correcting a hyper-convergence or a hyper-divergence condition;

FIG. 5 is a flowchart of exemplary method steps to detect and correct hyper-convergence and hyper-divergence conditions;

FIG. 6A is a schematic diagram illustrating one embodiment of a data analysis unit configured to detect an improper rendering condition owing to the concurrent occurrence of a scene change and a significant disparity change;

FIG. 6B is a schematic diagram illustrating one embodiment for detecting the concurrent occurrence of a scene change and a significant disparity change in successive image frames;

FIG. 6C is a schematic diagram illustrating one embodiment for correcting the improper rendering condition owing to the concurrent occurrence of a scene change and a significant disparity change;

FIG. 7 is a flowchart of method steps to detect and correct the inappropriate rendering condition owing to the concurrent occurrence of a scene change and a significant disparity change;

FIG. 8 is a schematic flowchart of exemplary method steps for rendering stereoscopic images; and

FIG. 9 is a schematic view illustrating an implementation of a computing device for rendering stereoscopic images.

### DETAILED DESCRIPTION OF EMBODIMENTS

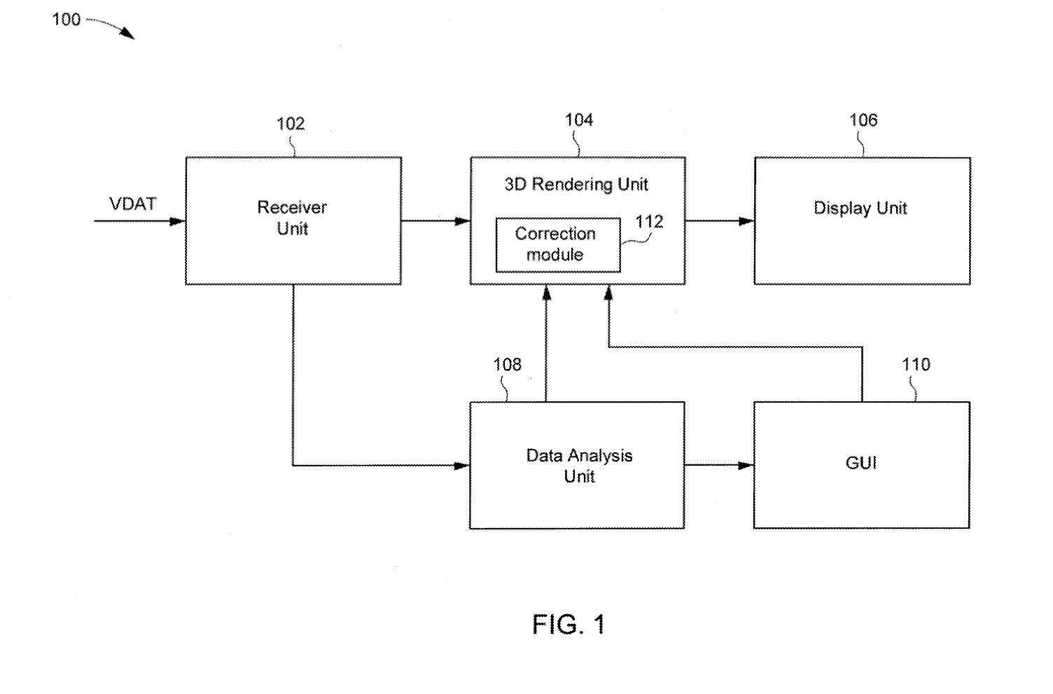

FIG. 1 is a simplified block diagram illustrating one embodiment of a stereoscopic rendering system 100. The stereoscopic rendering system 100 can be configured to receive video data VDAT, apply computation of the video VDAT data so as to generate a plurality of stereoscopic image frames, and present the stereoscopic image frames on a display screen so that a viewer with binocular vision can see an image with depth perception. Examples of the stereoscopic rendering systems 100 can include home television apparatuses, computer devices, tablet computers, mobile phones, smart-phones, etc. In the illustrated example, the stereoscopic rendering system 100 can comprise a receiver unit 102, a 3D rendering unit 104, a display unit 106, a data analysis unit 108 and a graphics user interface (GUI) unit 110. In some embodiments, the receiver unit 102, the 3D rendering unit 104, the data analysis unit 108 and the graphics user interface (GUI) unit 110 may be integrated into a single processing unit. In alternate embodiments, one or more of the receiver unit 102, the 3D rendering unit 104, the data analysis unit 108 and the graphics user interface (GUI) unit 110 may be configured as one or more separate processing unit according to the required design.

The receiver unit 102 can receive video data VDAT from a source device (not shown) via a wireless or a wired communication channel, and pass the video data VDAT to the 3D rendering unit 104 and the data analysis unit 108. When a wireless communication channel is used, the receiver unit 102 may proceed to demodulate the video data. Should a wire communication channel be implemented, the receiver unit 102 may receive the video data through a connection interface such as High-Definition Multimedia Interface (HDMI), Digital Visual Interface (DVI), DisplayPort, and the like. In some embodiments, the received video data VDAT can include stereoscopic pairs of image frames that can be respectively associated with left and right eye views. In alternate embodiments, the video data VDAT can include 2D image frames, and depth maps associated therewith.

The 3D rendering unit 104 can apply various computation on the video data VDAT, and generate stereoscopic pairs of left-eye and right-eye image frames of a full size to be presented on the display unit 106. Computing operations performed by the 3D rendering unit 104 can include, without limitation, up scaling the received video data, video decoding, and format analysis. In some embodiments, the 3D rendering unit 104 may generate one or more virtual stereoscopic image frame based on a 2D image frame and a depth map contained in the video data VDAT. In other embodiments, the 3D rendering unit 104 may also be configured to construct disparity and/or depth maps associated with image frames contained in the received video data VDAT.

The data analysis unit 108 can receive the video data VDAT, and analyze the video data VDAT to detect the occurrence of improper rendering conditions in image frames of the video data VDAT. An improper rendering condition can refer to certain data configurations that may cause improper stereoscopic rendering on the display unit 106, resulting in vision discomfort.

In some embodiments, the data analysis unit 108 may issue a control signal to the GUI unit 110 when an improper rendering condition is detected. The GUI unit 110 can then output a corresponding warning message that may be rendered via the 3D rendering unit 104 for presentation on the display unit 106. Accordingly, the viewer can be alerted of the presence of unsuitable stereoscopic content and take appropriate measures, e.g., by temporarily stopping watching the display screen. The warning message may be displayed as long as unsuitable stereoscopic content occurs.

In alternate embodiments, the data analysis unit 108 may notify the 3D rendering unit 104 that the occurrence of an improper rendering condition has been detected. The 3D rendering unit 104 can include a correction module 112 that can apply actions to correct the data for protecting the viewer's vision.

There are different case scenarios in which stereoscopic content may be rendered inappropriately and cause vision discomfort. According to a first scenario, unsuitable rendering may occur when the left view image and the right view image are reversed. This condition, also called pseudo stereo condition, may cause a conflict between depth and perspective image.

According to a second scenario, unsuitable rendering may be the result of an excessive disparity range associated with the stereoscopic image frames rendered on the display screen. As a result, hyper-convergence or hyper-divergence may occur.

According to a third scenario, unsuitable rendering be caused by the concurrent occurrence of a scene change and a significant disparity change between successive image frames, which may cause eye strain.

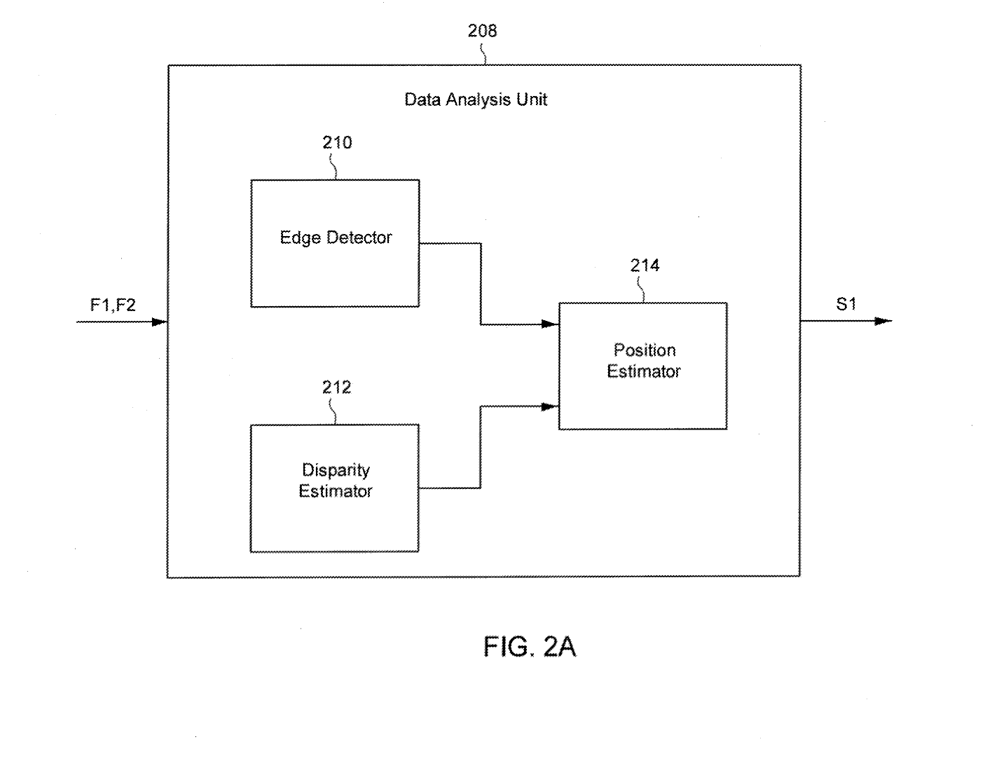

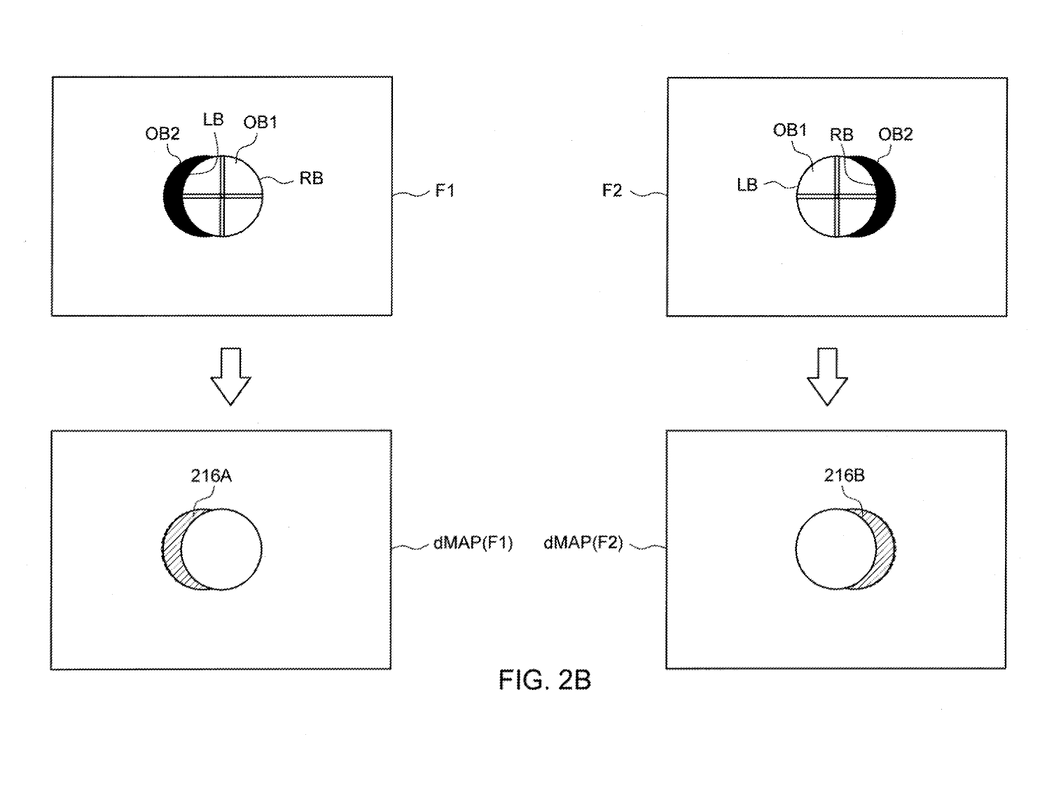

FIG. 2A is a schematic diagram illustrating one embodiment of a data analysis unit 208 configured to detect an improper rendering condition owing to the occurrence of a pseudo stereo condition. In one embodiment, the data analysis unit 208 can include an edge detector 210, a disparity estimator 212 and a position estimator 214. Suppose that the data analysis unit 208 receives a stereoscopic pair including a first image frame F1 as left-eye image frame, and a second image frame F2 as right-eye image frame. The edge detector 210 can analyze the image frames F1 and F2 to detect boundaries of features or objects represented in the image frames. The disparity estimator 212 can construct disparity maps respectively associated with the first and second image frames F1 and F2. The position estimator 214 can receive the boundary information from the edge detector 210 and the disparity maps computed by the disparity estimator 212, determine and compare the positions of occlusion holes in the disparity maps relative to the feature boundaries. Based on the determination by the position estimator 214, the data analysis unit 208 can issue a notification signal 51 indicating whether a pseudo stereo condition is present and swapping of the first and second image frames F1 and F2 is required.

FIG. 2B is a schematic diagram illustrating one embodiment for detecting a pseudo stereo condition. Assume that the first and second image frames F1 and F2 can represent a scene in which an object OB1 (e.g., a cover) is occluding at least a part of another object OB2 (e.g., an opening). The edge estimator 210 can apply computation on the first and second image frames F1 and F2 to detect feature edges in the image frames F1 and F2. Any known methods may be applied to detect the occurrence of feature edges. For example, a gradient operator may be computed for the pixels in the image frames F1 and F2, and local maximum in the gradient magnitude can be determined to detect the occurrence of each feature edge. Left and right side boundaries LB and RB of the object OB1 can be thereby detected.

Moreover, a disparity map dMAP(F1) associated with the first image frame F1 can be constructed by applying a forward stereo matching method, and a disparity map dMAP(F2) associated with the second image frame F2 can be constructed by applying a backward stereo matching method. The disparity maps dMAP(F1) and dMAP(F2) may be internally computed by the disparity estimator 212 provided in the data analysis unit 208, or externally provided to the data analysis unit 208.

As the disparity maps dMAP(F1) and dMAP(F2) are generated, occlusion holes 216A and 216B corresponding to regions in the disparity maps dMAP(F1) and dMAP(F2) where no stereo matching is found can be detected. The first image frame F1 is correctly applied as a left-eye image if the occlusion hole 216A detected in the associated disparity map dMAP(F1) is adjacent to the left side boundary LB of the occluding object OB1. In addition, the second image frame F2 is correctly applied as a right-eye image if the occlusion hole 216B detected in the associated disparity map dMAP(F2) is adjacent to the right side boundary RB of the occluding object OB1. In contrast, the occurrence of the pseudo stereo condition is detected when an occlusion hole found in the disparity map dMAP(F1) is located adjacent to a right side boundary of the occluding object OB1 (and/or an occlusion hole found in the disparity map dMAP(F2) is located adjacent to a left side boundary of the occluding object OB1). The notification signal S1 outputted by the data analysis unit 208 can accordingly indicate whether a pseudo stereo condition occurs, i.e., whether the first and second image frames F1 and F2 are correctly applied as left-eye and right-eye images. When a pseudo stereo condition occurs, the correction module 112 may apply correction by swapping the first and second image frames F1 and F2.

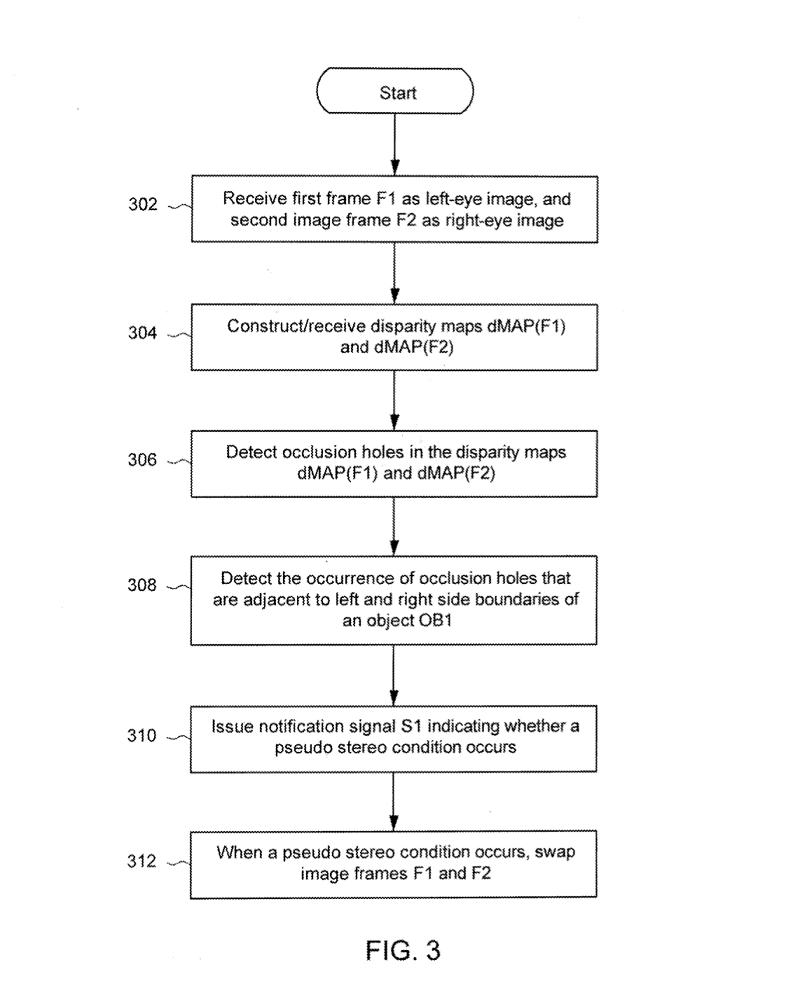

In conjunction with FIGS. 2A and 2B, FIG. 3 is a flowchart of exemplary method steps to detect and correct the occurrence of a pseudo stereo condition. In step 302, the data analysis unit 208 can receive a first image frame F1 as left-eye image, and a second image frame F2 as right-eye image. In step 304, the data analysis unit 208 can construct or receive the disparity maps dMAP(F1) and dMAP(F2) respectively associated with the first and second image frames F1 and F2. In step 306, the data analysis unit 208 can detect occlusion holes in the disparity maps dMAP(F1) and dMAP(F2). In step 308, the data analysis unit 208 can detect the occurrence of occlusion holes (such as the occlusion holes 216A and 216B shown in FIG. 2B) that are adjacent to certain predetermined boundaries of an occluding object OB1, i.e., left and right side boundaries LB and RB of the occluding object OB1.

In step 310, the data analysis unit 208 can issue the notification signal S1 indicating whether a pseudo stereo condition occurs. The occurrence of a pseudo stereo condition can be detected when one or more occlusion holes in the disparity map associated with the image frame F1 is located adjacent to a right side boundary of the occluding object OB1, and/or when one or more occlusion holes in the disparity map associated with the image frame F2 is located adjacent to a left side boundary of the occluding object OB1.

In step 312, when the signal S1 indicates the occurrence of a pseudo stereo condition, the correction module 112 can swap the first and second image frames F1 and F2.

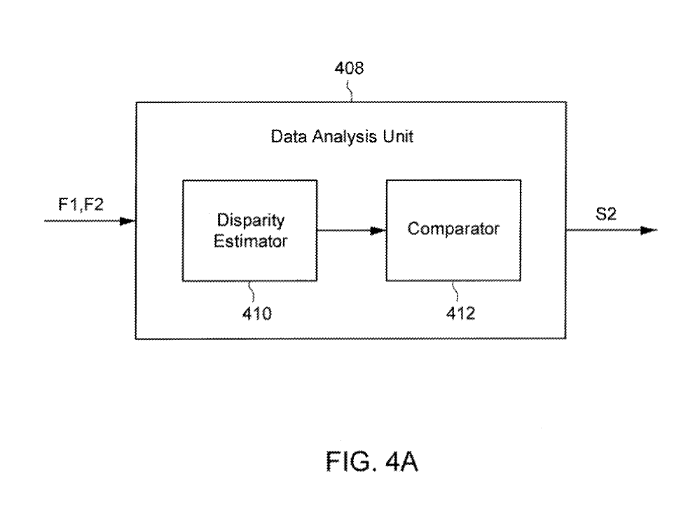

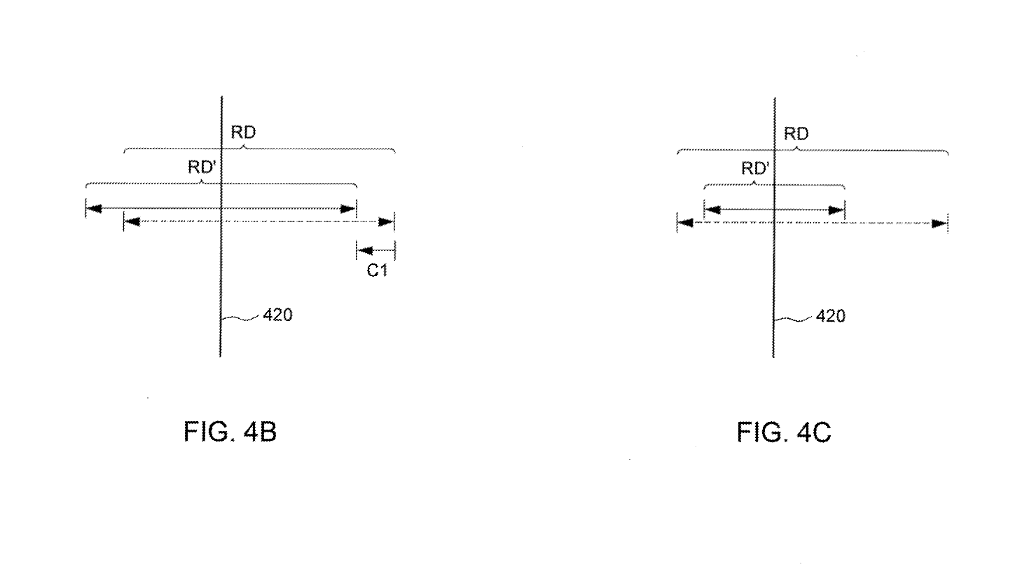

FIG. 4A is a schematic diagram illustrating one embodiment of a data analysis unit 408 configured to detect an improper rendering condition owing to the occurrence of hyper-convergence of hyper-divergence. In one embodiment, the data analysis unit 408 can include a disparity estimator 410 and a comparator 412. Suppose that the data analysis unit 408 receives a stereoscopic pair including a first image frame F1 as left-eye image, and a second image frame F2 as right-eye image. The disparity estimator 410 can construct at least one disparity map dMAP associated with the first and second image frames F1 and F2, and determine a minimum disparity value MIN and a maximum disparity value MAX in the disparity map dMAP. In alternate embodiments, the disparity map dMAP may be externally provided to the data analysis unit 408, such that the disparity estimator 410 only needs to determine the minimum disparity value MIN and the maximum disparity value MAX.

The minimum and maximum disparity values MIN and MAX can be respectively compared against two predetermined threshold values TH1 and TH2 via the comparator 412 to determine whether the total range of disparity data in the disparity map dMAP is within a safety range of binocular vision defined between the threshold values TH1 and TH2. In one embodiment, the safety range of disparity values can be defined as the numerical range [−50, +50], i.e., TH1 is equal to −50 and TH2 is equal to +50. According to the result of the comparison, a notification signal S2 can be issued indicating the position of the actual disparity range relative to the safety range and whether correction is required.

FIG. 4B is a schematic diagram illustrating one embodiment for correcting a hyper-convergence or a hyper-divergence condition. In some embodiments, the occurrence of hyper-convergence and hyper-divergence can be corrected by displacing a range of depth RD associated with the disparity range between the minimum and maximum disparity values MIN and MAX. The range of depth RD may represent the overall range in which depth can be perceived by a viewer in front of a display screen 420. The applied correction can include displacing the range of depth RD a distance C1 so as to form a correspondingly adjusted range of depth RD′ that is centered about the depth level of the display screen 420. In one embodiment, this displacement can be applied by adding an offset constant value to all depth values in a depth map associated with the first and second image frames F1 and F2. The depth map can contain depth values that are inversely proportional to the disparity values of the disparity map dMAP.

FIG. 4C is a schematic diagram illustrating another embodiment for correcting hyper-convergence and hyper-divergence conditions. The hyper-convergence and hyper-divergence conditions may also be corrected by reducing the range of depth RD associated with the disparity range between the minimum and maximum disparity values MIN and MAX. In some embodiments, this applied correction can include detecting foreground and background features in a depth map associated with the first and second image frames F1 and F2, and apply a different offset to the depth value of each pixel according to whether the pixel is in the foreground or background. This can result in shrinking the range of depth RD to form a correspondingly adjusted range of depth RD'.

It is worth noting that alternate embodiments can also combine the embodiments shown in FIGS. 4B and 4C to correct the hyper-convergence and hyper-divergence conditions. In other words, the depth map of the first and second image frames F1 and F2 can be altered so that the range of depth RD can be displaced so as to be centered about the depth level of the display screen 420 and also shrunk in size. With this correction, hyper-convergence and hyper-divergence conditions can be effectively reduced.

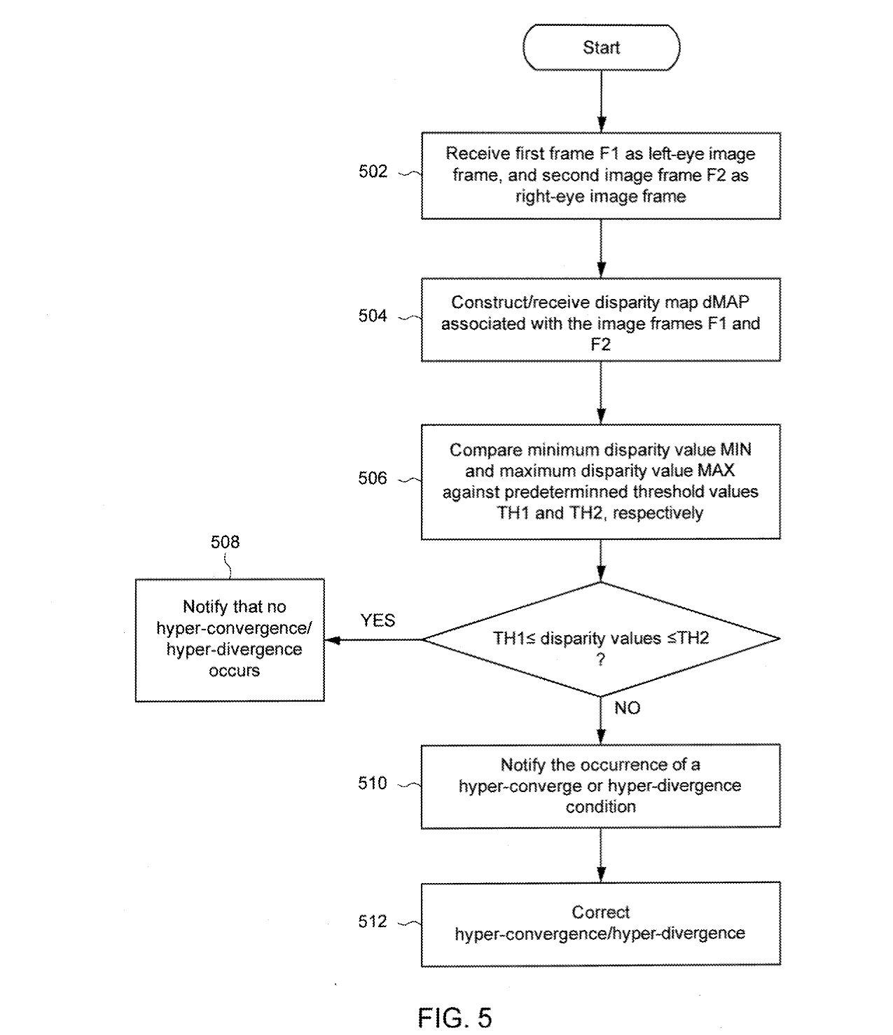

In conjunction with FIGS. 4A-4C, FIG. 5 is a flowchart of exemplary method steps to detect and correct hyper-convergence and hyper-divergence conditions. In step 502, the data analysis unit 408 can receive a first image frame F1 as left-eye image frame, and a second image frame F2 as right-eye image frame. In step 504, the data analysis unit 408 can construct or receive a disparity map dMAP associated with the first and second image frames F1 and F2. In step 506, the data analysis unit 408 can respectively compare a minimum disparity value MIN and a maximum disparity value MAX in the disparity map dMAP against predetermined threshold values TH1 and TH2.

In case the disparity values of the disparity map dMAP is within the range defined between the threshold values TH1 and TH2, the data analysis unit 408 in step 508 can issue a notification signal S2 indicating no occurrence of hyper-convergence or hyper-divergence.

When any of the minimum disparity value MIN and the maximum disparity value MAX is beyond the threshold values TH1 and TH2 (i.e., the range of disparity values in the disparity map dMAP extends beyond the safety range defined between the threshold values TH1 and TH2), the data analysis unit 408 in step 510 can issue a notification signal S2 indicating the occurrence of a hyper-convergence or hyper-divergence condition (hyper-convergence may occur when the maximum disparity value MAX is greater than the threshold value TH2, and hyper-divergence may occur when the minimum disparity value MIN is smaller than the threshold value TH1). Subsequently, the correction module 112 in step 512 can proceed to correct the hyper-convergence or hyper-divergence condition by adjusting the range of depth RD according to any of the methods described previously with reference to FIGS. 4B and 4C.

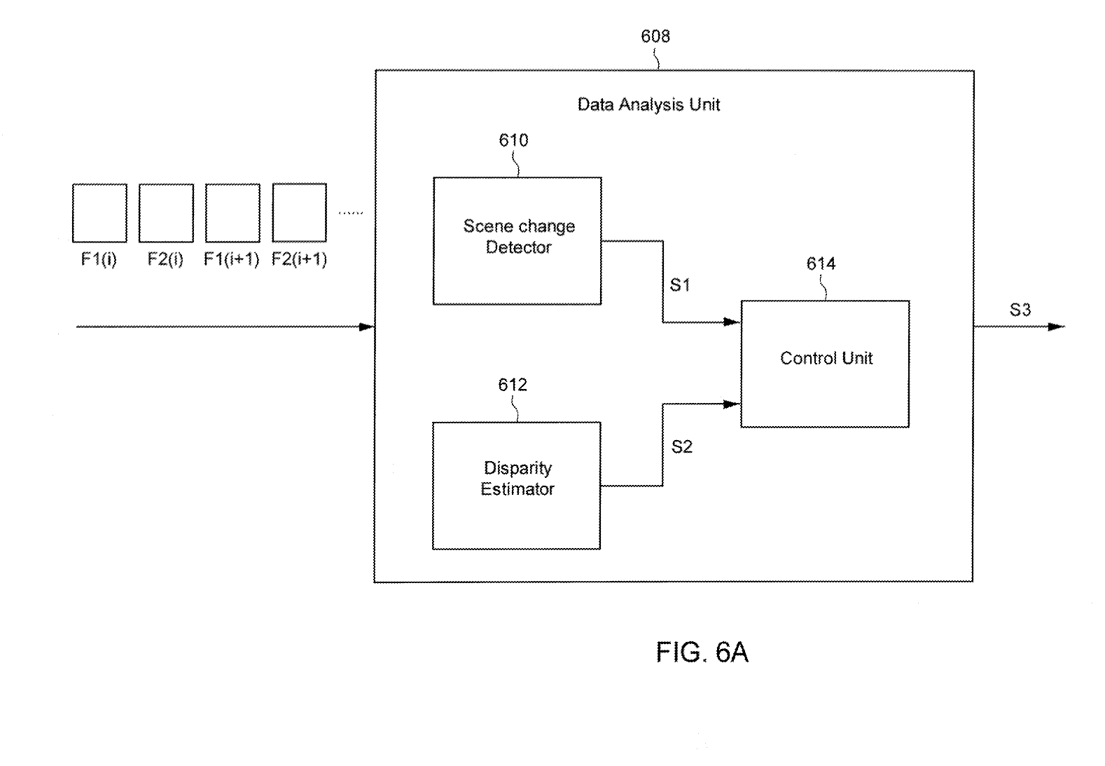

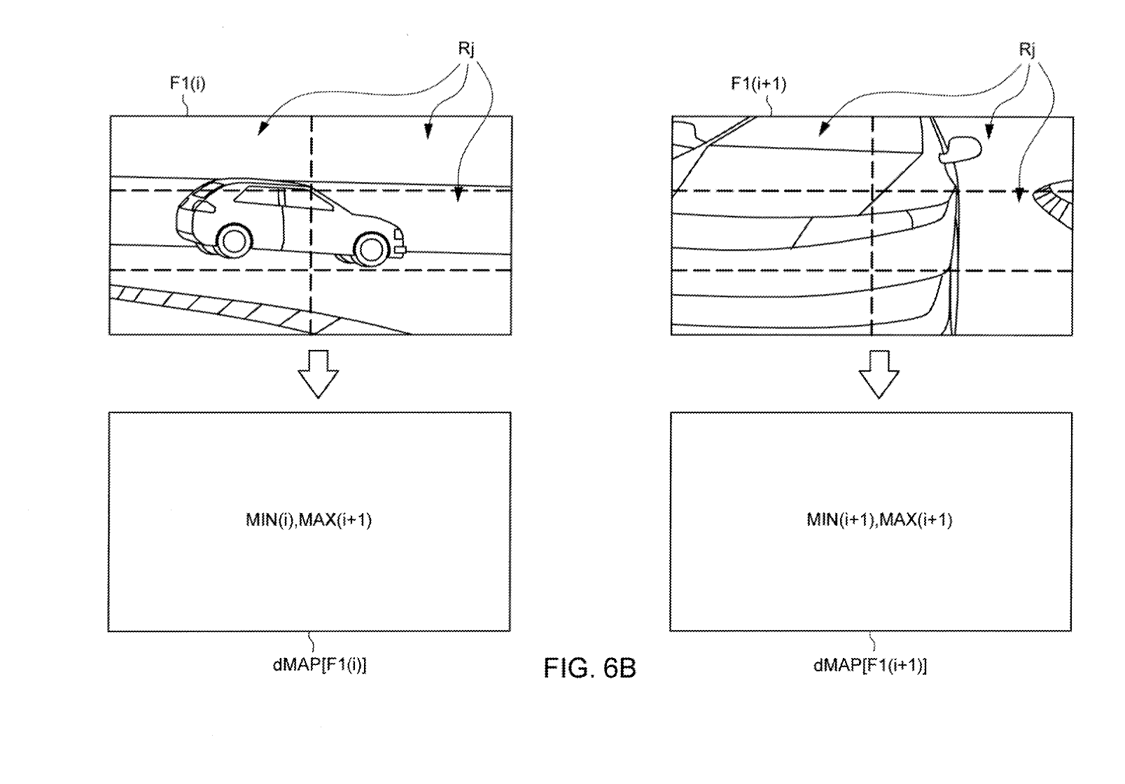

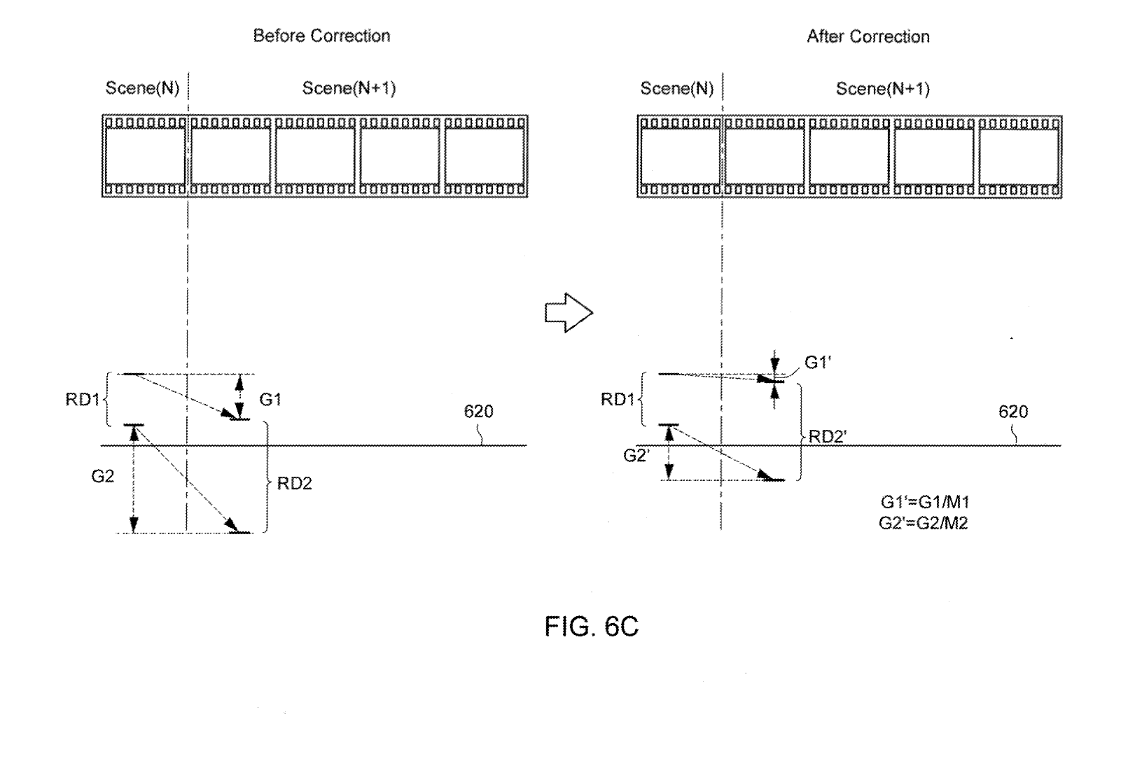

FIG. 6A is a schematic diagram illustrating one embodiment of a data analysis unit 608 configured to detect an improper rendering condition owing to the concurrent occurrence of a scene change and a significant disparity change. In one embodiment, the data analysis unit 608 can include a scene change detector 610, a disparity estimator 612 and a control unit 614. Suppose that the data analysis unit 608 receives a sequence of image frames F1(i) and F2(i) respectively as stereoscopic pairs of left-eye and right-eye image frames. By way of example, the sequence can include receiving the first image frame F1(i) as left-eye image, the second image frame F2(i) as right-eye image, then the first image frame F1(i+1) as left-eye image, the second image frame F2(i+1), and so on. The scene change detector 610 can analyze the content of two successive image frames F1(i) and F1(i+1) to detect whether a scene change occurs, and issue a first result signal 51 to the control unit 614. The disparity estimator 612 can construct disparity maps associated with the image frames F1(i) and F1(i+1), determine the occurrence of a significant disparity change, and issue a second result signal S2 to the control unit 614. The control unit 614 can compare the first and second result signals s1 and s2, and issue a notification signal S3 indicating whether an improper rendering condition occurs.

FIG. 6B is a schematic diagram illustrating one embodiment for detecting the concurrent occurrence of a scene change and a significant disparity change in successive image frames. In one embodiment, a scene change can be detected based on two successive image frames F1(i) and F1(i+1) applied as left-eye images. However, the scene change may also be detected based on two successive image frames F2(i) and F2(i+1) applied as right-eye images. A scene change may be detected by evaluating the difference between the image frames F1(i) and F1(i+1). For example, assume that the image frames F1(i) and F1(i+1) contain image data in a given color format, e.g., the luminance (Y), blue chroma (Cb) and red chroma (Cr) model (i.e., “YCbCr” model). Moreover, each of the image frames F1(i) and F1(i+1) can be similarly divided into a plurality of regions Rj (delimited with dotted lines). In one embodiment, the scene change between the image frames F1(i) and F1(i+1) can be assessed by evaluating whether a color difference and a difference in the count of feature edges between the image frames F1(i) and F1(i+1) respectively exceed certain thresholds. The color difference between the image frames F1(i) and F1(i+1) can be assessed with the following expressions (1) and (2) respectively computed for each of the regions Rj:

Luminance difference: |Y(i)−Y(i+1)|>L1 (1)

wherein Y(i) is the average luminance of the region Rj in the image frame F1(i), Y(i+1) is the average luminance of the same region Rj in the image frame F1(i+1), and L1 is a predetermined first threshold value; and

Color difference: |N(i)−N(i+1)|>L2 (2),

wherein N(i) is the average color (e.g., Cb or Cr) of the region Rj in the image frame F1(i), N(i+1) is the average color (e.g., Cb or Cr) of the same region Rj in the image frame F1(i+1), and L2 is a predetermined second threshold value.

Feature edges can include the edges of objects represented in the image frames. For example, feature edges may include the edges of the car featuring in the image frames F1(i) and F1(i+1) illustrated in FIG. 6B. Any known methods may be applied to detect the occurrence of feature edges including, without limitation, the use of a gradient operator computed for the pixels in the image frames F1(i) and F1(i+1), and local maximum in the gradient magnitude can be determined to detect the occurrence of each feature edge. The difference in the count of detected feature edges between the image frames F1(i) and F1(i+1) can be assessed with the following expression (3) respectively computed for each of the regions Rj:

Edge count difference: |E(i)−E(i+1)|>L3 (3),

wherein E(i) is the count of feature edges detected in the region Rj of the image frame F1(i), E(i+1) is the count of feature edges detected in the same region Rj of the image frame F1(i+1), and L3 is a predetermined third threshold value.

Each of the aforementioned expressions (1), (2) and (3) can be respectively computed for each region Rj in the image frames F1(i) and F2(i+1). For example, the expressions (1), (2) and (3) can be computed for the region at the top left corner of the image frames F1(i) and F2(i+1), then for the region horizontally adjacent thereto, and so on. Each time one of the conditions in the expressions (1), (2) and (3) is met for one region Rj, a score counter SC tracked by the scene change detector 610 can be updated (e.g., by increasing the score counter SC by a certain value). After all of the regions Rj are processed, the occurrence of a scene change can be detected when the score counter SC is greater than a threshold value L4, i.e., SC>L4.

Referring again to FIG. 6B, the data analysis unit 608 can compute a disparity map dMAP[F1(i)] associated with the image frame F1(i), and a disparity map dMAP[F1(i+1)] associated with the image frame F1(i+1). A significant disparity change between the image frames F1(i) and F1(i+1) can be found when any of the following expressions (4) and (5) is met:

|MAX(i+1)−MAX(i)|>L5 (4),

wherein MAX(i+1) is the maximum disparity value of the disparity map dMAP[F1(i+1)], and MAX(i) is the maximum disparity value of the disparity map dMAP [F1(i)];

|MIN(i+1)−MIN(i)|>L6 (5),

wherein MIN(i+1) is the minimum disparity value of the disparity map dMAP[F1(i+1)], and MIN(i) is the minimum disparity value of the disparity map dMAP[F1(i)].

When a scene change and a significant disparity change are found, the notification signal S3 can be issued to indicate the occurrence of an improper rendering condition. The correction unit 112 can then correct the improper rendering condition by adjusting depth data associated with the image frame F1(i+1).

FIG. 6C is a schematic diagram illustrating one embodiment for correcting the improper rendering condition owing to the concurrent occurrence of a scene change and a significant disparity change. Assume that a last stereoscopic pairs representing a scene (N) on a display screen 620 has a first range of depth RD1 with respect to the display screen 620, and a first stereoscopic pair representing a next scene (N+1) different from the scene (N) has a second range of depth RD2. G1 designates a gap difference between a maximum depth value of the first range of depth RD1 and a maximum depth value of the second range of depth RD2, and G2 designates a gap difference between a minimum depth value of the first range of depth RD1 and a minimum depth value of the second range of depth RD2. The improper rendering condition can be corrected by converting the second range of depth RD2 into an adjusted second range of depth RD2′ that reduces the gap differences G1 and G2. In one embodiment, the adjusted second range of depth RD2′ can be such that the gap difference G1′ between the maximum depth value of the first range of depth RD1 and the maximum depth value of the second range of depth RD2′, and the gap difference G2′ between the minimum depth value of the first range of depth RD1 and the minimum depth value of the second range of depth RD2′ are respectively computed with the following expressions (6) and (7):

G1′=G1/M1 (6), and

G2′=G2/M2 (7),

wherein M1 and M2 can be equal or different adjustment factors.

In one embodiment, the correction module 112 can determine the values of the gap differences G1 and G2, and apply different adjustment factors G1′ or G2′depending on the size of the gap differences G1 and G2. The greater gap difference, the higher adjustment factor is applied. For example, suppose that the gap difference G2 is greater than the gap difference G1 (as shown in FIG. 6C), the adjustment factor M2 is greater than M1. In case the gap difference G1 is greater than the gap difference G2, then the adjustment factor M1 can be greater than M2.

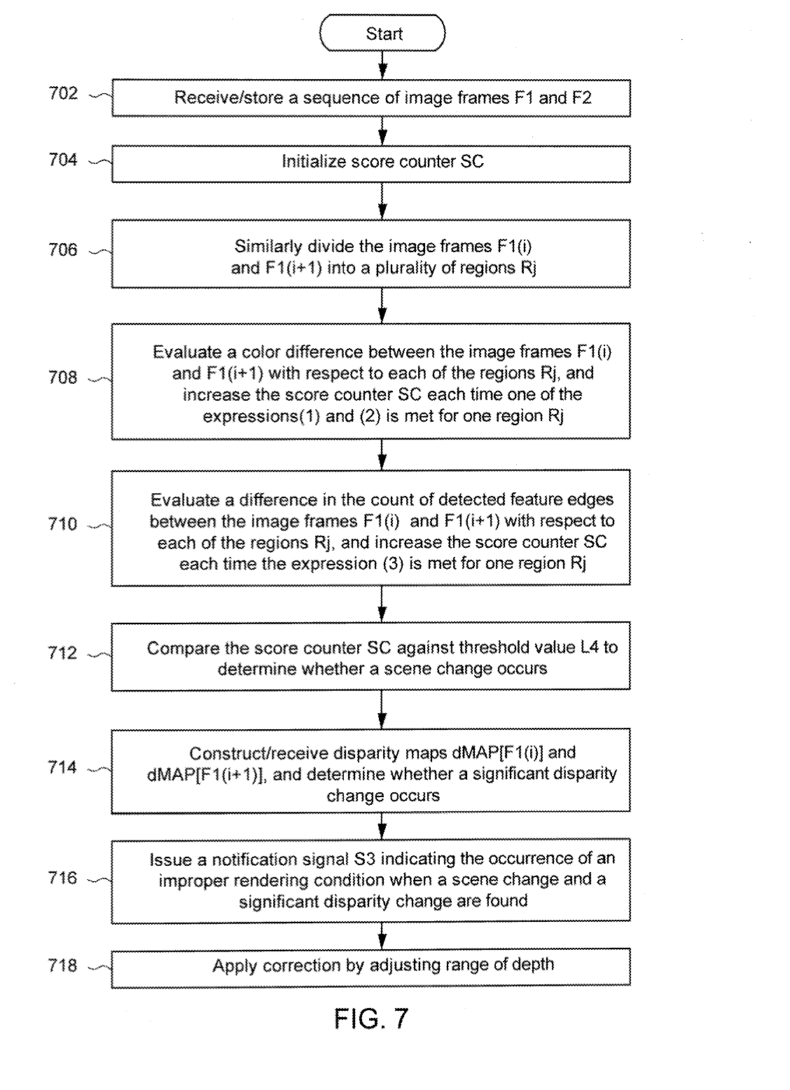

In conjunction with FIGS. 6A-6C, FIG. 7 is a flowchart of exemplary method steps to detect and correct the inappropriate rendering condition owing to the concurrent occurrence of a scene change and a significant disparity change. In step 702, the data analysis unit 608 can receive a sequence of images frames F1 and F2, and store the image frames F1 and F2 in a frame buffer. In step 704, the score counter SC can be initialized to zero, and two image frames F1(i) and F1(i+1) applied as successive left-eye images can be divided into a plurality of regions Rj in step 706. In alternate embodiments, two image frames F2(i) and F2(i+1) applied as successive right-eye images may also be used rather than the image frames F1(i) and F1(i+1).

In step 708, the data analysis unit 608 can respectively compute the aforementioned expressions (1) and (2) to evaluate a color difference between the image frames F1(i) and F1(i+1) with respect to each of the regions Rj, and update by increasing the score counter SC each time one of the expressions (1) and (2) is met for one given region Rj.

In step 710, the data analysis unit 608 can detect feature edges, compute the aforementioned expression (3) to evaluate a difference in the count of detected features edges between the image frames F1(i) and F1(i+1) with respect to each of the regions Rj, and update by increasing the score counter SC each time the expression (3) is met for one given region Rj.

In step 712, the score counter SC can be compared against the threshold value L4 after all of the regions Rj have been processed to determine whether a scene change occurs. In step 714, the data analysis unit 608 can construct or receive the disparity map dMAP[F1(i)] and the disparity map dMAP[F1(i+1)], and determine whether a significant disparity change occurs. As described previously, a significant disparity change may be detected by evaluating whether the difference between the maximum disparity values and/or minimum disparity values in the disparity map dMAP[F1(i)] and dMAP[F1(i+1)] exceeds a predetermined threshold. When a scene change and a significant disparity change are found, the data analysis unit 608 in step 716 can accordingly issue the notification signal S3 indicating the occurrence of an improper rendering condition. In step 718, the correction module 112 can accordingly apply correction by adjusting the range of depth as described previously with reference to FIG. 6C.

It will be appreciated that aside the foregoing, other types of improper rendering conditions may also be detected. For example, another embodiment can provide a disparity map associated with a stereoscopic pair of left-eye and right-eye image frames, and compare the maximum and minimum disparity values of the disparity map. When the maximum disparity value is almost equal to the minimum disparity value, the current image frames are substantially similar to each other and likely correspond to a same 2D image. Accordingly, the disparity map may be adjusted to provide more apparent stereoscopic rendering.

In other embodiments, the luminance and/or color components of the image frames F1 and F2 can also be evaluated against predetermined thresholds to detect the occurrence of inappropriate luminance/color parameters. When unsuitable luminance/color data are detected, adjustment may be applied to provide proper rendering.

With the systems and methods described herein, various improper rendering conditions can be detected while stereoscopic content is being displayed, and appropriate actions can be timely applied to protect the viewer's vision.

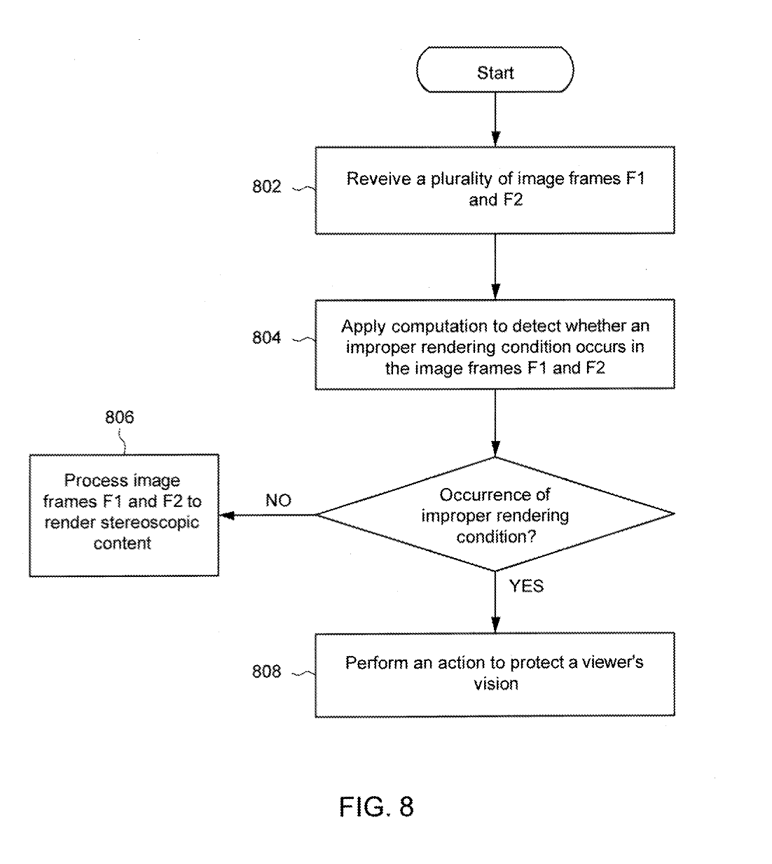

In conjunction with FIGS. 1-7, FIG. 8 is a schematic flowchart of exemplary method steps for rendering stereoscopic images. In step 802, the stereoscopic rendering system 100 can receive a plurality of image frames F1 and F2. In step 804, the stereoscopic rendering system 100 can apply computation to detect whether an improper rendering condition occurs in any of the received image frames F1 and F2. Any of the methods described previously may be applied to detect the occurrence of improper rendering conditions, such as the pseudo stereo condition, the hyper-convergence or hyper-divergence condition, the concurrent occurrence of a scene change and significant disparity changes, etc. When no improper rendering condition is detected, step 806 can be performed whereby the image frames F1 and F2 can be processed to provide stereoscopic rendering on the display unit 106. In case an improper rendering condition is detected, an action can be performed to protect a viewer's vision in step 808. In some embodiment, the action can include presenting a warning message on the display unit 106 for alerting the viewer of the improper rendering condition. For example, the data analysis unit 108 may issue a control signal to the GUI unit 110 when an improper rendering condition is detected. The GUI unit 110 can then output a corresponding warning message that may be rendered via the 3D rendering unit 104 for presentation on the display unit 106. It will be appreciated that the warning message may be presented in a visual form (such as text) which may also be accompanied with an audio alert (such as an alert sound). In alternate embodiments, it may also be possible to issue an audio signal as warning message.

In other embodiments, the action performed in step 808 can include applying adequate correction as described previously. Appropriate correction can be applied depending on the detected type of improper rendering condition, such as pseudo stereo condition, hyper-convergence condition, hyper-divergence condition, and the concurrent occurrence of a scene change and a significant disparity change.

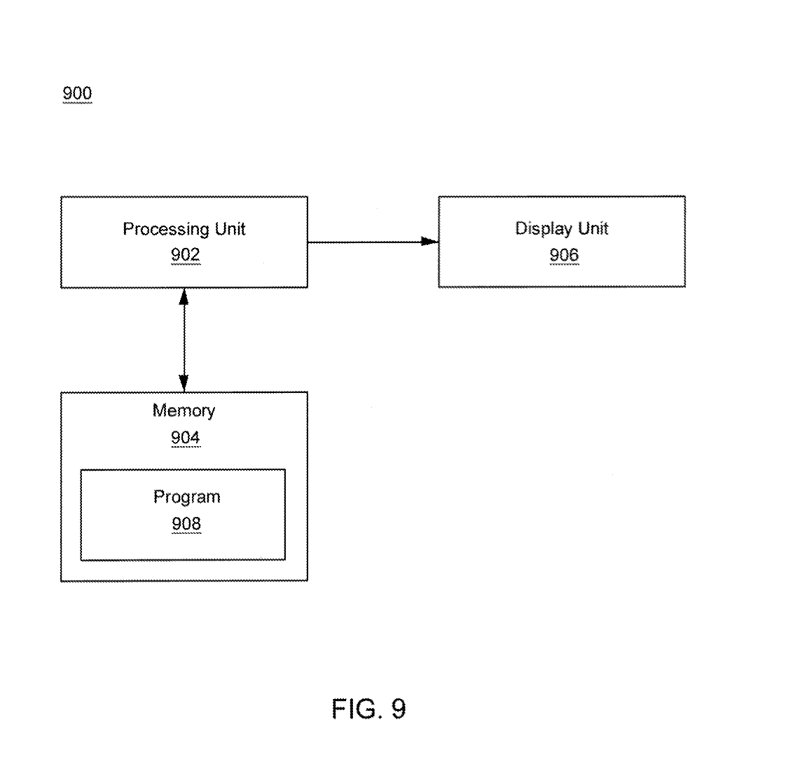

The features and embodiments described herein can be implemented in any suitable form including hardware, software, firmware or any combination thereof FIG. 9 is a schematic view illustrating an implementation of a computing device 900 that includes a processing unit 902, a memory 904 coupled with the processing unit 902, and a display unit 906. The aforementioned method steps for detecting and correcting improper rendering conditions may be implemented at least partly as a computer program 908 stored in the memory 904. The processing unit 902 can execute the computer program 908 to render stereoscopic image frames on a display unit 906 as described previously.

At least one advantage of the systems and methods described herein is the ability to detect and correct improper rendering conditions. Accordingly, more comfortable stereoscopic viewing can be provided to protect the viewer's vision.

While the embodiments described herein depict different functional units and processors, it is understood that they are provided for illustrative purpose only. The different elements, components and functionality between different functional units or processors may be may be physically, functionally and logically implemented in any suitable way. For example, functionality illustrated to be performed by separate processors or controllers may also be performed by a single processor or controller.

Realizations in accordance with the present invention therefore have been described in the context of particular embodiments. These embodiments are meant to be illustrative and not limiting. Many variations, modifications, additions, and improvements are possible. Accordingly, plural instances may be provided for components described herein as a single instance. Structures and functionality presented as discrete components in the exemplary configurations may be implemented as a combined structure or component. These and other variations, modifications, additions, and improvements may fall within the scope of the invention as defined in the claims that follow.

What is claimed is:

1. A method of rendering stereoscopic images, comprising:
receiving a plurality of stereoscopic image frames to be rendered on a display screen;
detecting the occurrence of an improper rendering condition in the stereoscopic image frames; and
performing an action for protecting a viewer's vision when the improper rendering condition is detected.

2. The method according to claim 1, wherein the step of detecting the occurrence of an improper rendering condition comprises:
detecting one or more occlusion holes in a disparity map associated with an image frame that includes an occluding object; and
determining the occurrence of a pseudo stereo condition when one or more of the occlusion holes is located adjacent to a predetermined boundary of the occluding object, wherein the predetermined boundary is a left-side boundary when the image frame is a left-eye image frame, and the predetermined boundary is a right-side boundary when the image frame is a right-eye image frame.

3. The method according to claim 1, wherein the step of detecting the occurrence of an improper rendering condition comprises:
providing a disparity map;
comparing a minimum disparity value and a maximum disparity value in the disparity map respectively against a first threshold value and a second threshold value; and
determining the occurrence of a hyper-convergence or hyper-divergence condition when any of the minimum disparity value and the maximum disparity value is beyond the first and second threshold values.

4. The method according to claim 1, wherein the step of detecting the occurrence of an improper rendering condition comprises:
detecting the concurrent occurrence of a scene change and a significant disparity change in successive image frames.

5. The method according to claim 4, wherein the step of detecting the occurrence of a scene change comprises:
evaluating a color difference between two successive left-eye or right-eye image frames; and
evaluating a difference in a count of feature edges between the two successive left-eye or right-eye image frames.

6. The method according to claim 5, wherein the left-eye or right-eye image frames are similarly divided into a plurality of regions, and the steps of evaluating the color difference and the difference in the count of feature edges are respectively applied with respect to each of the regions.

7. The method according to claim 6, wherein the step of detecting the occurrence of a scene change further comprises:
updating a score counter each time the color difference is greater than a first threshold value for one of the regions;
updating the score counter each time the difference in the count of feature edges is greater than a second threshold value for one of the regions; and
determining the occurrence of the scene change when the score counter is greater than a predetermined threshold value.

8. The method according to claim 1, wherein the step of performing an action for protecting a viewer's vision comprises:
presenting a warning message on a display screen indicating the occurrence of the improper rendering condition.

9. The method according to claim 1, wherein the step of performing an action for protecting a viewer's vision comprises:
adjusting a range of depth associated with the image frames.

10. The method according to claim 9, wherein the step of adjusting the range of depth comprises displacing the range of depth so that the range of depth is centered on a display screen, and/or reducing the range of depth.

11. A stereoscopic rendering system comprising:
a display unit; and
a processing unit coupled with the display unit, the processing unit being configured to:
receive a plurality of stereoscopic image frames;
detect the occurrence of an improper rendering condition in the image frames; and
perform an action for protecting a viewer's vision when the improper rendering condition is detected.

12. The system according to claim 11, wherein the processing unit is configured to detect the occurrence of an improper rendering condition by performing a plurality of steps comprising:
detecting one or more occlusion holes in a disparity map associated with an image frame that includes an occluding object; and
determining the occurrence of a pseudo stereo condition when one or more of the occlusion holes is located adjacent to a predetermined boundary of the occluding object, wherein the predetermined boundary is a left-side boundary when the image frame is a left-eye image frame, and the predetermined boundary is a right-side boundary when the image frame is a right-eye image frame.

13. The system according to claim 11, wherein the processing unit is configured to detect the occurrence of an improper rendering condition by performing a plurality of steps comprising:
comparing a minimum disparity value and a maximum disparity value in a disparity map respectively against a first threshold value and a second threshold value; and
determining the occurrence of a hyper-convergence or hyper-divergence condition when any of the minimum disparity value and the maximum disparity value is beyond the first and second threshold values.

14. The system according to claim 11, wherein the processing unit is configured to detect an improper rendering condition caused by the concurrent occurrence of a scene change and a significant disparity change in successive image frames.

15. The system according to claim 14, wherein the processing unit is configured to detect the occurrence of a scene change by performing a plurality of steps comprising:
similarly dividing two successive left-eye or right-eye image frames into a plurality of regions;
evaluating a color difference between the two successive left-eye or right-eye image frames with respect to each of the regions; and
evaluating a difference in a count of feature edges between the two successive left-eye or right-eye image frames with respect to each of the regions.

16. The method according to claim 15, wherein the processing unit is configured to detect the occurrence of a scene change by further performing a plurality of steps comprising:
updating a score counter each time the color difference is greater than a first threshold value for one of the regions;
updating the score counter each time the difference in the count of feature edges is greater than a second threshold value for one of the regions; and
determining the occurrence of the scene change when the score counter is greater than a predetermined threshold value.

17. The system according to claim 11, wherein the processing unit is configured to perform an action for protecting a viewer's vision by presenting a warning message on a display screen indicating the occurrence of the improper rendering condition.

18. The system according to claim 11, wherein the processing unit is configured to perform an action for protecting a viewer's vision by adjusting a range of depth associated with the image frames.

19. A computer readable medium comprising a sequence of program instructions which, when executed by a processing unit, causes the processing unit to:
detect an improper rendering condition from a plurality of stereoscopic image frames, wherein the improper rendering condition includes a pseudo stereo condition, a hyper-convergence condition, a hyper-divergence condition, and the concurrent occurrence of a scene change and a significant disparity change; and
perform an action for protecting a viewer's vision when the improper rendering condition is detected.

20. The computer readable medium according to claim 19, further comprising instructions which, when executed by the processing unit, causes the processing unit to:
render a warning message on a display unit to alert a viewer of the occurrence of the improper rendering condition.
